(19) United States
(12) Patent Application Publication
(10) Pub. No.: US 2007/0014187 A1
(43) Pub. Date: Jan. 18, 2007

(54) WHISK-A-BOWL

(76) Inventor: Randy Kaas, Phoenix, AZ (US)

Correspondence Address: WEISS & MOY PC, 4204 NORTH BROWN AVENUE, SCOTTSDALE, AZ, 85251, US

(21) Appl. No.: 11/457,282

(22) Filed: Jul. 13, 2006

Related U.S. Application Data
(60) Provisional application No. 60/699,809, filed on Jul. 14, 2005.

(51) Int. Cl. B01F 7/18

(52) U.S. Cl. 366/325.6

(57) ABSTRACT

An improved whisk and method therefor is disclosed. The whisk has an attachment end dimensioned to be coupled to an electric mixer and has coils coupled about and along at least a portion of the length of its tines. The coils scrape ingredients from the rim, inner walls, and bottom of a mixing bowl and move the ingredients in a substantially inward and substantially downward direction toward the middle of the whisk during whisking. And the substantially downward spiral shape of the coils cuts through the ingredients in a horizontal and diagonal pattern which moves the ingredients at a much faster rate.

### CROSS-REFERENCE TO RELATED APPLICATION

This application claims priority to a corresponding provisional application U.S. Ser. No. 60/699,809, filed Jul. 14, 2005 in the name of the applicant of this application.

### FIELD OF THE INVENTION

This invention relates generally to baking and cooking and, more specifically, to a whisk having coils that provide for more efficient whisking.

### BACKGROUND OF THE INVENTION

When cooking or baking, certain ingredients are often mixed with an electric mixer. These mixers are equipped with various attachments, the shapes of which are particular to a specific type of process. For example, flat beaters are used for almost everything from heavy cookie dough batter to lighter cake mixtures, and dough hooks are used for mixing and kneading yeast bread dough. And wire beaters (whisks) are used to add air to whipped mixes such as whipping cream, eggs, and egg whites.

A common problem with using electric mixers, however, is that much of the ingredients are pushed toward the interior walls of the mixing bowl, out of the whisk's range. In order to solve this problem, some have resorted to using a small rubber spatula to scrape the sides of the mixing bowl and to manually push the ingredients back toward the whisk. This may prove to be dangerous, however, because there is great potential for the user's hand or the rubber spatula to be caught in the moving tines. It is also inconvenient for the user to constantly have to tend to the mixer to ensure that the ingredients are being evenly and thoroughly incorporated.

Therefore, a need existed for a whisk dimensioned to scrape the rim, the interior walls, and the bottom of the mixing bowl during whisking and to guide the ingredients inwardly and downwardly toward the middle area of the whisk while adding air volume to the ingredients in a fashion faster that traditionally shaped whisks.

### SUMMARY OF THE INVENTION

An object of the present invention is to provide an improved whisk.

Another object of the present invention is to provide a whisk dimensioned to scrape the rim, the interior walls, and bottom of a mixing bowl during whisking.

A further object of the present invention is to provide a whisk dimensioned to guide the ingredients inwardly and downwardly toward the middle area of the whisk.

A still further object of the present invention is to provide a whisk that will allow for faster, more efficient, and more thorough whisking of ingredients.

A still further object of the present invention is to provide a whisk that increases the volume of ingredients in a faster and more efficient manner.

### BRIEF DESCRIPTION OF THE PREFERRED EMBODIMENTS

In accordance with the present invention, an improved whisk is disclosed. The whisk comprises an attachment end dimensioned to be coupled to an electric mixer, at least one tine coupled to the attachment end, and at least one coil being coupled about and along at least a portion of the length of the at least one tine.

In accordance with the present invention, an improved whisk is disclosed. The whisk comprises at least four tines substantially curved to correspond to the shape of the interior walls of a mixing bowl, at least four flexible coils, wherein each coil is spiraling substantially downwardly about and along at least a portion of the length of one of the tines, at least one stop coupled to at least one of a first end and a second end of each tine, each stop for holding each coil in place thereby creating tension in each coil which allows each coil to bend outwardly.

In accordance with the present invention, a method for whisking ingredients is disclosed. The method comprises the steps of providing an improved whisk comprising an attachment end dimensioned to be coupled to an electric mixer, at least one tine coupled to the attachment end, at least one coil being coupled about and along at least a portion of the length of the at least one tine, moving the ingredients in a substantially inward and substantially downward direction toward the middle of the whisk by the coils, scraping the ingredients from at least one of the inner walls, rim, and bottom of a mixing bowl by the coils.

### BRIEF DESCRIPTION OF THE DRAWINGS

FIG. 1 is a top view of a whisk of the present invention.

FIG. 2 is a perspective view of the whisk of FIG. 1.

FIG. 3 is a side view of the whisk of FIG. 1.

FIG. 4 is a side view of the whisk of FIG. 1.

FIG. 5 is a side view of the whisk of FIG. 1.

FIG. 6 is a top view of the whisk of the present invention shown without inner tines.

FIG. 7 is a side view of the whisk of FIG. 6.

FIG. 8 is a side view of the whisk of FIG. 6.

FIG. 9 is an elevated perspective view of the whisk of FIG. 6.

FIG. 10 is a side view of the whisk of FIG. 6.

FIG. 11 is a side view of the whisk of FIG. 6 shown in use with a mixing bowl.

### DETAILED DESCRIPTION OF THE PREFERRED EMBODIMENTS

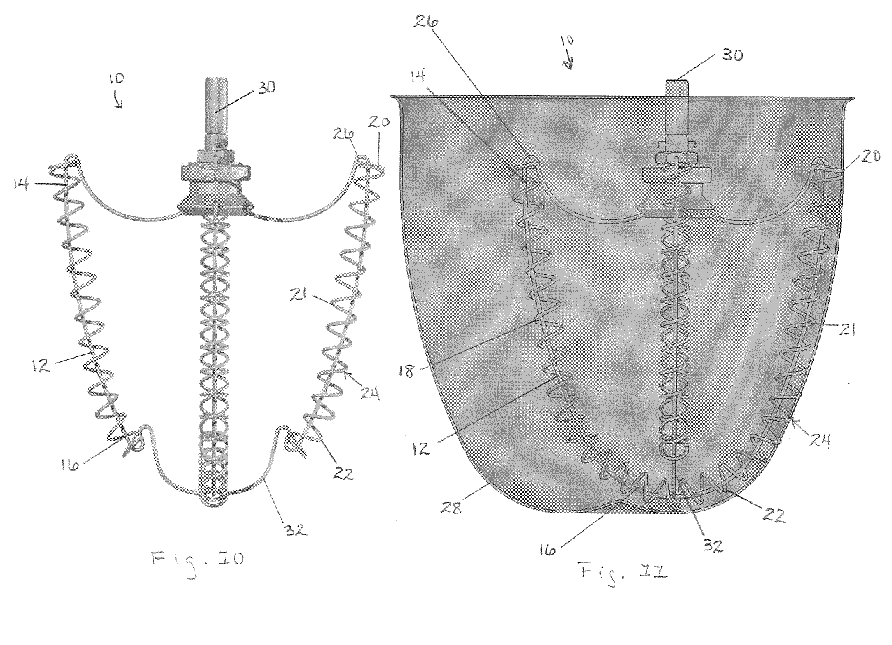

FIGS. 1-11 together disclose an improved whisk, referred to hereinafter as whisk 10, for use with an electric mixer (not shown). The whisk 10 comprises an attachment end 30 dimensioned to be coupled to the electric mixer, tines 12, and coils 18 coupled about and along the length of the tines 12. The tines 12 are preferably oriented substantially parallel to the attachment end 30.

Referring now to FIGS. 1-5, the whisk 10 is shown having six tines 12 in total and FIGS. 6-11 show a whisk 10 having four tines 12 in total. Although the Figures show the whisk 10 has having four or six tines 12 in total, it should be clearly understood that further substantial benefit may be derived from an alternative total number of tines 12.

While FIGS. 1-5 show the whisk 10 having four outer tines 12a, referred to generically as tines 12, and two inner tines 12b, referred to generically as tines 12, it should be clearly understood that further substantial benefit may be derived from an alternative ratio of outer tines 12a to inner tines 12b. It should also be understood that substantial benefit may be derived from the whisk 10 having no inner tines 12b, as shown in FIGS. 6-11.

The whisk 10 is shown as having a coil 18 spiraled about each of the tines 12. Although FIGS. 1-5 show that the whisk 10 has four outer coils 18a, referred to generically as coils 18, and two inner coils 18b, referred to generically as coils 18, it should be clearly understood that further substantial benefit may be derived from an alternative total number of coils 18 as well as an alternative ratio of outer coils 18a to inner coils 18b. Substantial benefit may also be derived from a whisk 10 having a no inner coils 18b, as shown in FIGS. 6-11. Furthermore, the number of coils 18 may be increased or decreased depending on the volume and speed a user desires to attain.

The outer coils 18a of FIGS. 1-5 and all of the coils of FIGS. 6-11 are shown as being dimensioned to scrape the rim, the interior walls, and the bottom of a mixing bowl 28 (see FIG. 11) during whisking. Each of those coils 18 that scrape the mixing bowl 28 are shown as extending along at least a portion of the length of its tine 12. The coil 18 is preferably similar to a helix, meaning that it maintains an equal distance from the tine 12 as it wraps about the tine 12. However, it should be clearly understood that substantial benefit may be derived from a coil 18 that tapers as it wraps about the tine 12. Each of those coils 18 that scrape the mixing bowl 28 is shown as having a first end 20 dimensioned to scrape proximate the rim, a middle portion 21 for scraping the interior walls, and a second end 22 (see FIGS. 2-5 and FIGS. 7-11) dimensioned to scrape proximate the bottom of the mixing bowl 28.

The tines 12 of the coils 18 that scrape the mixing bowl 28 preferably correspond to the shape of the mixing bowl 28 and those coils 18 that scrape the mixing bowl 28 are also preferably flexible so as to allow them to flex outwardly to conform to the shape of the mixing bowl 28. In so flexing, those coils 18 are able to scrape the rim, the interior walls, and the bottom of the mixing bowl 28 during whisking.

The tines 12 may have a stop 26 proximate the first end 14 (see FIGS. 2-5 and FIGS. 7-11) of the tine 12 and may have another stop 26 proximate the second end 16 (see FIGS. 2-5 and FIGS. 7-11) of the tine 12. The stops 26 hold the first end 20 and the second end 22 of the coils 18 in place, thereby creating tension in the coil 18 which allows the coil 18 to flex outwardly to scrape the rim, the interior walls, and the bottom of the mixing bowl 28 during whisking. It should be understood that substantial benefit may be derived from those tines 12 having only one stop 26 proximate the first end 14 to hold the first end 20 of the coil 18 in place while allowing the second end 22 of the coil 18 to be free-floating, thereby causing the coil 18 to rely on centrifugal force when scraping the rim, the interior walls, and bottom of the mixing bowl 28. It should also be clearly understood that substantial benefit may be derived from the tines 12 having no stops 26. And although FIGS. 2-5 show that only the outer tines 12a have stops 26, it should be clearly understood that further substantial benefit may be derived from the inner tines 12b having stops 26 to hold the inner coils 18b in place.

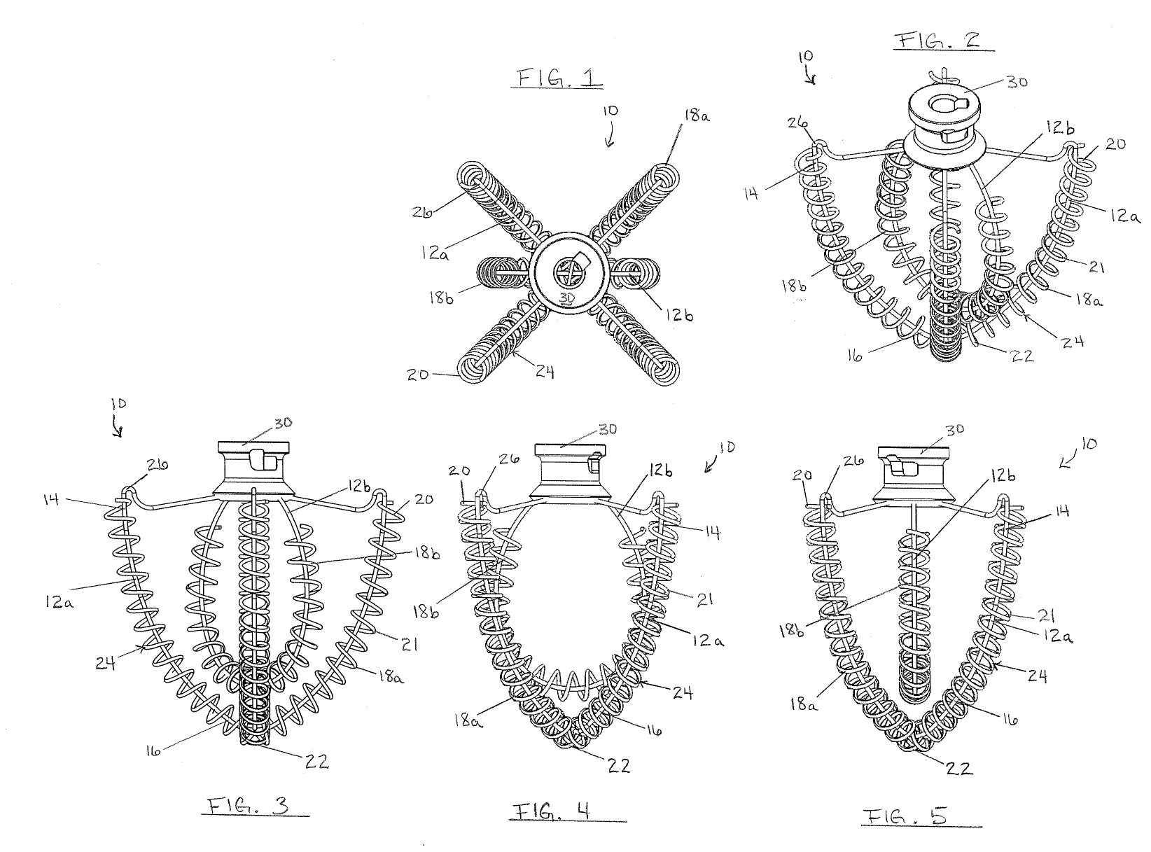

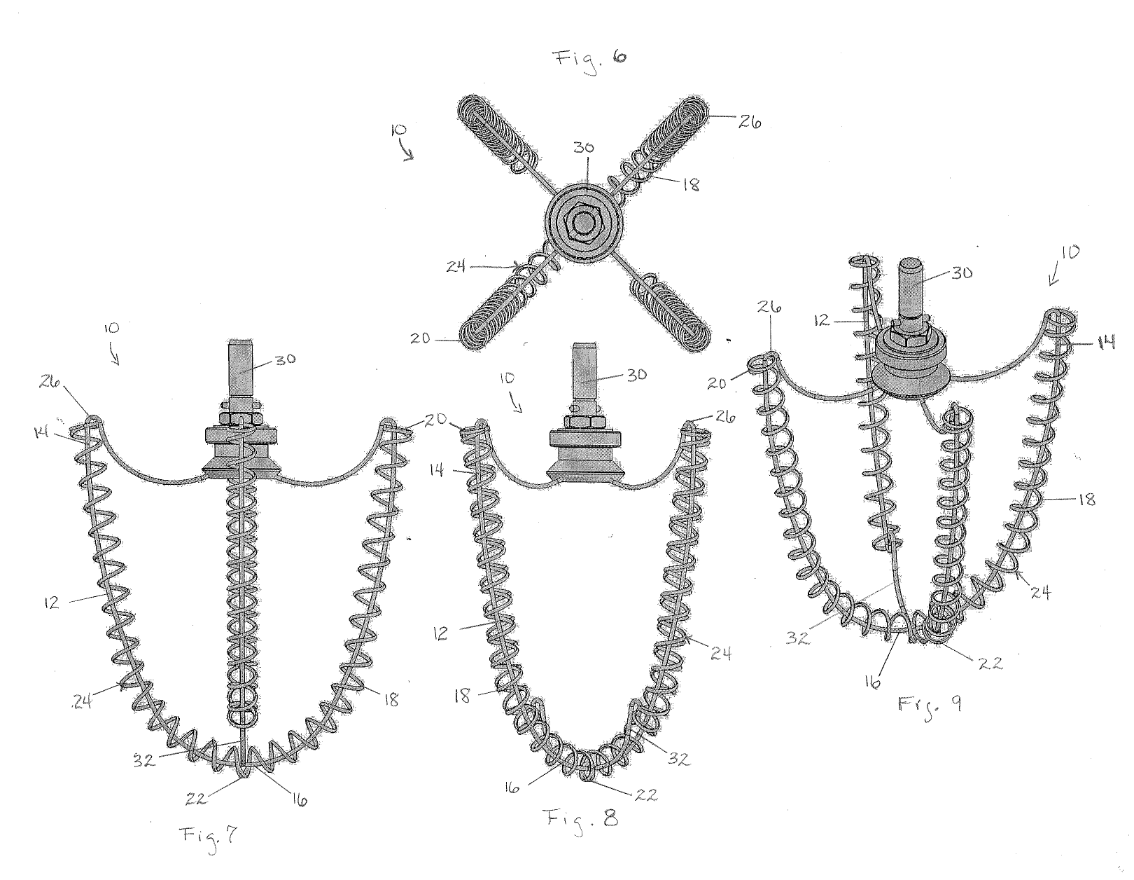

Each tine 12 may have its own coil 18. However, substantial benefit may be derived from tines 12 that share a coil 18 (see FIGS. 4 and 7). FIGS. 4 and 7 show that two opposing tines 12 share a coil 18, but it should be understood that a coil 18 may be shared by more than two tines 12.

Tines 12 may be coupled to each other at their second ends 16 (see FIGS. 4 and 9). FIG. 4 shows two opposing inner tines 12b being coupled together at their second ends 16, but it should be understood that more than two tines 12 may be coupled together at their second ends 16 and that either inner tines 12b or outer tines 12a may be connected. The tines 12 may be connected directly to each other at their second ends 16 or they may be coupled by a connector 32. Tines 12 may be connected either way or both ways on the same whisk 10. For example, FIG. 9 shows two opposing tines 12 coupled directly to each other at their second ends 16 and also shows two other opposing tines 12 coupled to each other at their second ends 16 by a connector 32.

The whisk 10 of the present invention changes the direction that the ingredients are whisked. Traditional substantially vertical tines whisks tend to just cut through the ingredients in a vertical pattern. The substantially downward spiral shape of the coils 18 cuts through the ingredients in a horizontal and diagonal pattern which moves the ingredients at a much faster rate. From a top view, if the whisk 10 is moving in a clockwise direction with respect to the mixing bowl 28, the coils 18 are preferably positioned such that they spiral substantially downwardly in a left-hand spiral (i.e. counterclockwise direction) about the tines 12. If the whisk 10 is moving in a counterclockwise direction with respect to the mixing bowl 28, the coils 18 are preferably positioned such that they spiral substantially downwardly in a right-hand spiral (i.e. clockwise direction) about the tines 12. When in use, the downward spiral of the coils 18 causes a downward auger motion, which forces or directs the ingredients inward and downward toward the middle area of the whisk 10, as opposed to the current whisks which centrifugally force the ingredients in an outward and upward direction. Although it is preferred that the coils 18 spiral substantially downwardly, it should be clearly understood that substantial benefit may still be derived from the coils 18 spiraling upwardly.

The coils 18 also help to increase the lineal surface area of the tines 12. Due to the increased lineal surface area, the whisk 10 of the present invention is able to significantly reduce whisking time and is able to increase the amount of air delivered to the ingredients thereby increasing the volume of the ingredients.

The coils 18 that come in contact with the mixing bowl 28 may have a coating 24 to prevent the coils 18 from scratching the mixing bowl 28. The coating 24 may be made of silicone, rubber, or any other suitable material that will flex upon impact with the interior walls or bottom of the mixing bowl. Such a flexible coating 24 will allow for more efficient and thorough scraping of the rim, the interior walls, or bottom of the mixing bowl 28. It should be clearly understood, however, that substantial benefit may be derived from all of the coils 18 having coating 24, none of the coils 18 having coating 24, or any combination of outer coils 18a and inner coils 18b having coating 24. It should be clearly understood that substantial benefit may be derived from the coating 24 being a molded structure dimensioned to be fit about the coils 18 or from the coating 24 being integral to the coils 18.

While the invention has been particularly shown and described with reference to preferred embodiments thereof, it will be understood by those skilled in the art that the foregoing and other changes in form and details may be made therein without departing from the spirit and scope of the invention. For example, although it is preferred that the coils spiral about the tines, it should be clearly understood that substantial benefit may be derived from a whisk having coils that are integral with the tines and from a whisk having coils but no tines, so long as the coils are capable of scraping the rim, the interior walls, and bottom of the mixing bowl. As a further example, it should also be clearly understood that substantial benefit may be derived from a whisk having a combination of coils and substantially flat tines (similar to those used in a flat beater) wherein the flat tines are also dimensioned to scrape the interior walls and bottom of the mixing bowl.

I claim:

1. An improved whisk comprising:
an attachment end dimensioned to be coupled to an electric mixer;
at least one tine coupled to said attachment end; and
at least one coil being coupled about and along at least a portion of the length of said at least one tine.

2. The whisk of claim 1 wherein said at least one tine being oriented substantially parallel to said attachment end.

3. The whisk of claim 1 comprising:
at least four tines; and
at least four coils, each said coil being coupled about and along at least a portion of the length of one of said tines.

4. The whisk of claim 1 wherein each coil comprises:
a first end for scraping proximate the rim of a mixing bowl;
a middle portion for scraping the inner walls of said mixing bowl; and
a second end for scraping proximate the bottom of said mixing bowl.

5. The whisk of claim 1 wherein each tine being substantially curved to correspond to the shape of the interior walls of a mixing bowl.

6. The whisk of claim 1 wherein each coil being substantially flexible to bend outwardly to scrape at least one of the rim, the interior walls, and the bottom of a mixing bowl.

7. The whisk of claim 1 comprising at least one stop coupled to at least one of a first end and a second end of each tine, each stop for holding each coil in place thereby creating tension in each coil which allows each coil to bend outwardly.

8. The whisk of claim 1 wherein opposing tines share a single coil.

9. The whisk of claim 1 wherein opposing tines being connected to each other at one end.

10. The whisk of claim 1 wherein opposing tines being coupled to each other at one end by a connector.

11. The whisk of claim 1 comprising:
at least two outer tines;
at least two outer coils, each of said outer coils coupled about and along at least a portion of the length of one of said outer tines;
at least two inner tines; and
at least two inner coils, each of said inner coils coupled about and along at least a portion of the length of one of said inner tines.

12. The whisk of claim 11 wherein each outer coil comprises:
a first end for scraping proximate the rim of a mixing bowl;
a middle portion for scraping the inner walls of said mixing bowl; and
a second end for scraping proximate the bottom of said mixing bowl.

13. The whisk of claim 11 wherein each outer tine being substantially curved to correspond to the shape of the interior walls of said mixing bowl.

14. The whisk of claim 11 wherein each outer coil being substantially flexible to bend outwardly to scrape at least one of the rim, the interior walls and the bottom of said mixing bowl.

15. The whisk of claim 11 comprising at least one stop coupled to at least one of a first end of each outer tine and a second end of each outer tine, each stop for holding each outer coil in place thereby creating tension is each outer coil which allows each outer coil to bend outwardly.

16. The whisk of claim 1 wherein each coil being positioned to spiral about each tine.

17. The whisk of claim 1 wherein each coil being coated with a resilient material that will allow for more efficient and thorough scraping of at least one of the rim, interior walls and the bottom of said mixing bowl.

18. An improved whisk comprising:
at least four tines substantially curved to correspond to the shape of the interior walls of a mixing bowl;
at least four flexible coils, wherein each said coil spiraling substantially downwardly about and along at least a portion of the length of one of said tines;
at least one stop coupled to at least one of a first end and a second end of each tine, each stop for holding each coil in place thereby creating tension in each coil which allows each coil to bend outwardly.

19. The whisk of claim 18 wherein two opposing tines being connected to each other at their second ends and sharing a single coil, and wherein any remaining opposing tines being connected to each other at their second ends by a connector.

20. The whisk of claim 18 wherein each coil comprises:
a first end for scraping proximate the rim of a mixing bowl;
a middle portion for scraping the inner walls of said mixing bowl; and
a second end for scraping proximate the bottom of said mixing bowl.

21. A method for mixing ingredients comprising the steps of:
providing an improved whisk comprising:
an attachment end dimensioned to be coupled to an electric mixer;
at least one tine coupled to said attachment end; and
at least one coil being coupled about and along at least a portion of the length of said at least one tine;
moving said ingredients in a substantially inward and substantially downward direction toward the middle of said whisk by said coils;
scraping said ingredients from at least one of the inner walls, rim, and bottom of a mixing bowl by said coils.

22. The method of claim 21 wherein said whisk comprises:
at least four tines; and
at least four flexible coils, wherein each said coil spiraling substantially downwardly about and along at least a portion of the length of one of said tines.

23. The method of claim 21 further comprising the step of flexing said coils outwardly to conform to the shape of at least one of the interior walls and the bottom of said mixing bowl.
